(19) United States
(12) Patent Application Publication
(10) Pub. No.: US 2011/0030136 A1
(43) Pub. Date: Feb. 10, 2011

(54) BED PROVIDED WITH A BATHTUB

(76) Inventor: Ki Jun Kim, Seoul (KR)

Correspondence Address: RABIN & Berdo, PC, 1101 14TH STREET, NW, SUITE 500, WASHINGTON, DC, 20005, US

(21) Appl. No.: 12/936,812

(22) PCT Filed: Apr. 6, 2009
(86) PCT No.: PCT/KR09/01746

§ 371 Date: Oct. 7, 2010

(30) Foreign Application Priority Data
Apr. 8, 2008 (KR) 10-2008-0032584

(51) Int. Cl. A61G 7/047; A61H 33/00; A47C 31/00; A61G 7/008

(52) U.S. Cl. 4/547; 5/11; 5/655.5; 5/607

(57) ABSTRACT

The present invention relates to a bed for patients, which is used in the nursing of physically disabled individuals and patients with severe symptoms who have limited ability to move due to a medical condition such as a stroke or an accident. The bed is provided with a bathtub in such a way as to allow relatively uncomplicated nursing in a way which maintains the patient's mental stability and bodily cleanliness by allowing immediate washing and hair washing while the patient is lying on the bed.

### BACKGROUND OF THE INVENTION

1. Field of the Invention

The present invention relates to a bed provided with a bathtub for patients, and more particularly, to a bed provided with a bathtub for bathing or washing sick persons in bed, specially when taking care persons who are not able to move out freely because of an accident or diseases such as a stroke, thereby stabilizing the soul and body of patients, and keeping the body clean to make caring easier.

2. Description of the Related Art

In general, a bed for patients in a hospital, etc. is provided with a mattress and a caster underneath to make movement easier, and a handle for increasing a side of the bed by a certain angle to make care more comfortable.

However, the conventional bed for patients is just for sleeping or taking a treatment, and so it has a considerable inconvenience for a caregiver to clean the body of the severely handicapped patient.

In other words, when washing the hair of the patient or bathing the patient in the past, he has to be moved to another place or simply washed with water in a bowl or with a damp towel on bed for patients' sanitary needs.

Accordingly, care giving for patients was very difficult and insanitary so that a solution has been needed to overcome the problem.

As an idea to meet the needs, a Patent Registration No. 10-0752479 (Title of Invention: Bed provided with a bathtub) is known.

As shown in FIG. 5, in the bed provided with a bathtub of Patent Registration No. 10-0752479, a bed leg 100 is positioned around corners under a bed plate 101 for the patient, and a moving wheel is positioned under the bed leg 100, and a bathtub 110 is set under the bed plate 101, and the bed leg 100 is inserted to a cylindrical bathtub fitting part 113 projected upward around the corners. A support plat fastener 123a is fixed from the lower side to the bed leg 100, and a chain block support 123 is set to stand over, and a chain block holder 122 is set on the chain block support 123. A chain block 120 for elevating the patient and a chain block 121 for elevating the bathtub are set at the chain block holder 122. For the chain block 120 and 121, a typical device is used which draws a chain block adjusting string 124 to move the chain 120a and 121a. The chain 120a and 121a. The chain 120a, 121 is connected to a rack 210 positioned at both sides of the bed plate 101, and also connected to an upper part of the bathtub 110. In case the chain block for elevating the patient is operated to draw the chain 120a upward, the rack 210 is moved upward, and in case the chain block for elevating the bathtub is operated to draw the chain 121a upward, the bathtub 110 is moved upward and the bathtub fitting part 113 is moved while inserted to the bed leg.

In addition, a water tank 140 is positioned under the bathtub 110, and the water tank 140 is set on a plate 100a connected to the bed leg 100, and water in the tank 140 is drained through a drain pipe 142 by a drain pump 141. To a drain hole 111 under the tank 140, a drain pipe 112 is fixed. The drain pipe 112 is moved upward/downward along with the bathtub 110 while inserted to the tank 140, and however the drain pipe 112 is not separated from the tank 140 and so water in the bathtub can be collected to the tank.

The conventional device is very complex and it is not stable because many chain blocks are set above the bed. Since the bed leg is inserted to the cylindrical bathtub fitting part projected upward around corners of the bathtub under the bed plate to lift the whole bathtub, the operation is so complex to cause inconvenience and high manufacture costs, and it cannot be widely used for the patients.

### SUMMARY OF THE INVENTION

An object of the present invention is to provide a bed provided with a bathtub in which the bathtub is formed by lifting a flexible and water-resistant side sheet which is formed integrally with a bed sheet on the upper frame of the bed, and in which a head part of the patient is made higher than a leg part of him on a lifted bed, thereby making the structure of the bed simple and making the care giving including bathing easier.

According to an aspect of the present invention, there is provided a bed provided with a bathtub, including: a lower frame having a caster under corners to obtain the mobility; an upper frame having an adjustable height which is positioned above the lower frame; an elevating member, which are positioned between the lower frame and the upper frame, for supporting the upper frame and adjusting a height of the upper frame; a bathtub sheet, which is integrally formed with a bed sheet on the upper frame and is made of a water resistant material to form a bathtub having a certain depth, including an outline part for keeping an external shape and a drain at a bottom side; a supporting member for supporting the bathtub sheet, which is positioned between the outline part of the bathtub sheet and the upper frame; and a slope adjusting unit for changing an angle in case of an elevation of the upper frame.

In the embodiment of the present invention, the elevating member includes a pair of elevating bars rotatably coupled by a central axis, which are positioned between the lower frame and the upper frame at both a left and a right side, and an elevating power unit, which is positioned at both sides of the elevating bars, for changing a coupling angle of the elevating bars by the expansion and contraction to control a height of the upper frame,

In the embodiment, the side ends of the elevating bars are rotatably coupled to the lower frame and the upper frame respectively by a lower hinge and an upper hinge, and other sides of the bars are respectively provided with a lower roller and an upper roller.

In the embodiment, the slope adjusting unit includes: an inclined plane having a slope guide in a certain area at a back side of the lower frame in order to guide the lower roller positioned at the end of the elevating bar and to increase a height of one side of the bed (a head side of the bed) in case of an elevation of the upper frame; and a lower roller for rolling along the inclined plane, which is positioned at an end of the elevating bar.

In the embodiment, the elevating power unit is a pneumatic cylinder for being expanded/contracted by pressure of compressed air supplied from an external pneumatic supply device.

In the embodiment, the elevating power unit includes a driving motor operated by electric power, and a bolt/nut relatively rotated by the motor to make the overall length expanded/contracted.

In the embodiment, the supporting member includes a cylinder and a rod for sliding in the cylinder and being expanded/contracted by human power.

In the embodiment, the bed sheet on the upper frame is provided with a hot water pipe therein in order to supply heat to water in bathtub.

In the present invention, in case of bathing or washing handicapped patients, a height of the bed sheet is minimized to allow patients to get on the bed very easily, and the height of the bed is adjusted to an optimal level to make the care giving easy. In addition, an angle of the bed sheet is adjusted to make a head part of the patients higher, thereby making the patient comfortable in bath and making the job of draining easy. The bathtub sheet can be lifted to give the patient comfort and to make the care giving easier.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a side view of showing a structure of a bed before it is lifted according to an embodiment of the present invention.

FIG. 2 is a cross sectional view of showing a structure of the bed of FIG. 1 with a lifted bathtub sheet.

FIG. 3 is a cross sectional view of showing a lifted structure of the bed in FIG. 2.

FIG. 4 is a plan view of showing the bed of FIG. 1.

FIG. 5 is a view of showing a conventional bed provided with a bathtub.

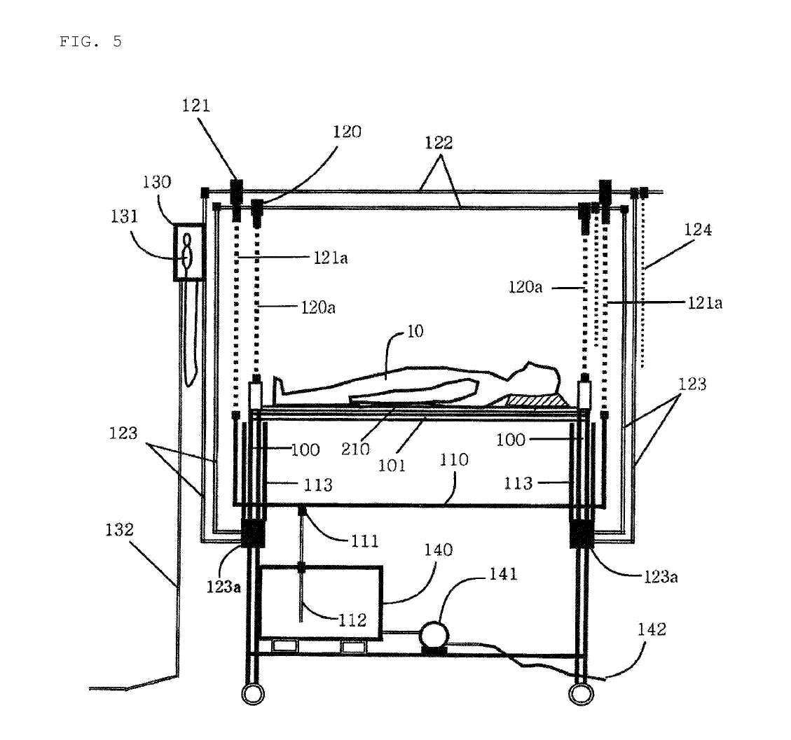

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

Hereinafter, an embodiment of the present invention will be described in detail according to the appended drawings.

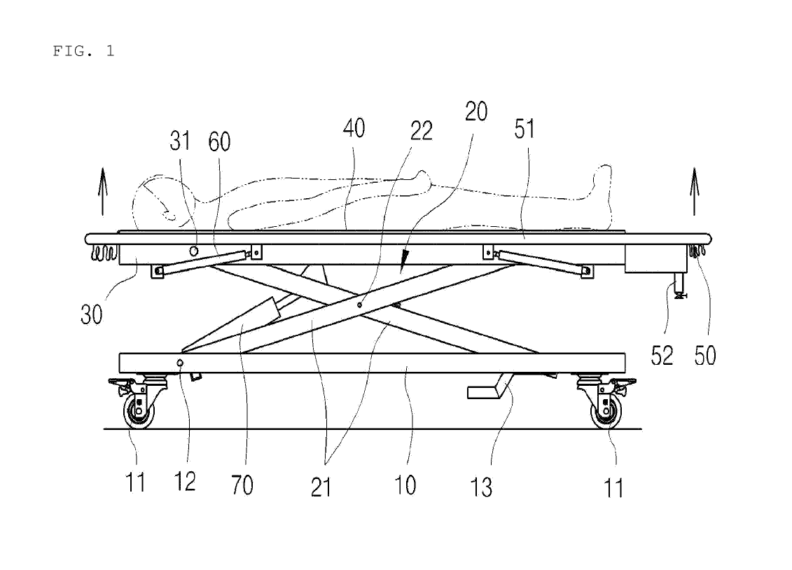

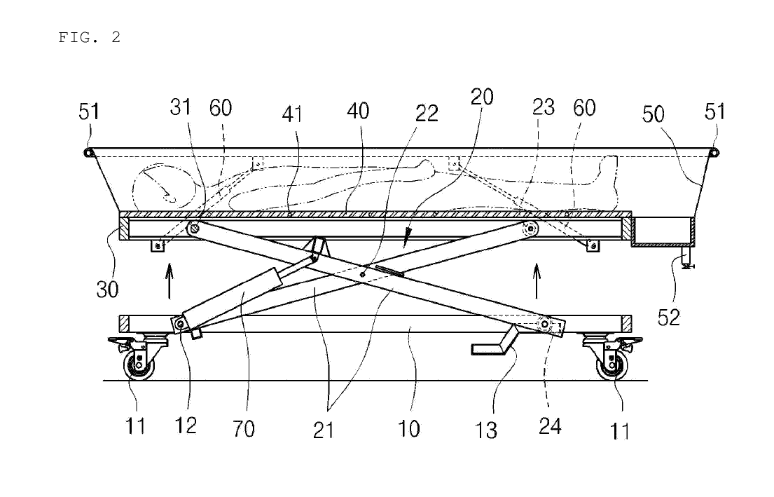

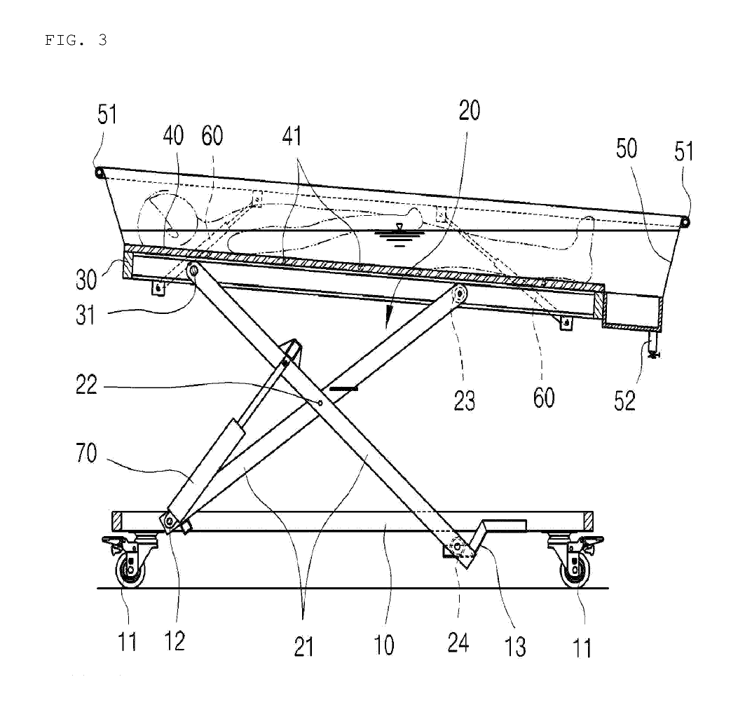

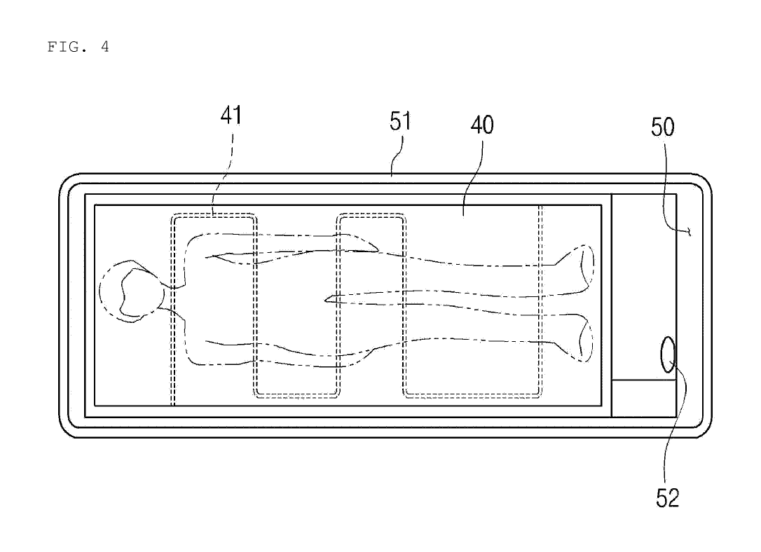

FIG. 1 is a side view of showing a structure of a bed before it is lifted according to an embodiment of the present invention; FIG. 2 is a cross sectional view of showing a structure of the bed with a bathtub sheet lifted; FIG. 3 is a cross sectional view of showing a structure of the lifted bed; and FIG. 4 is a plan view of showing the bed of FIG. 1.

As shown in the figures, the embodiment includes a lower frame 10; an upper frame 30; a bed sheet 40; an elevating member between the lower frame 10 and the upper frame 30; and a bathtub sheet 50 provided at the upper side of the bed sheet 40.

Under corners of the lower frame 10, a plurality of casters 11 are positioned to obtain the mobility.

The upper frame 30 is positioned above the lower frame 10, and its height is adjustable by the elevating member 20.

In other words, the elevating member 20, which is positioned between the lower frame 10 and the upper frame 30, is capable of supporting the upper frame 30 and also controlling a height of the upper frame 30, thereby making the bed comfortable.

The elevating member 20 includes a pair of elevating bars 21 which are positioned at the left and the right side and rotatably coupled by a central axis 22 at centers of each elevating bar; and an elevating power member 70 which is positioned at both sides of the elevating bar 21 for changing a coupling angle of the elevating bars 21 by the expansion and contraction to control a height of the upper frame 30.

The left side ends of the elevating bars 21 are rotatably coupled to the lower frame 10 and the upper frame 30 respectively by a lower hinge 12 and an upper hinge 31, and the right side ends are respectively provided with a lower roller 24 and an upper roller 23.

In the bed sheet 40 on the upper frame 30, a hot water pipe 41 is installed for circulating hot water from an independent boiler to provide heat to water of a bathtub in winter.

A bottom of the bathtub sheet 50 is integrally fixed to the bed sheet on the upper frame 30, and the sheet is made of a water resistant material of Urethane in order to form a bathtub with a certain depth in case a spinning wheel is lifted up.

Edges of the bathtub sheet 50 are provided with an outline part 51 of the elastic material such as plastics to keep an external shape, and its bottom side is provided with a drain 52.

In addition, between the outline part of the bathtub sheet 50 and the upper frame 30, a supporting member 60 is positioned to support the lifted bathtub sheet 50.

The supporting member 60 for supporting the lifted side walls of the bathtub sheet 50 includes a cylinder (pipe) and a rod for sliding in the cylinder, such as an expanded/contracted antenna, and an outer diameter of the rod is same as an internal diameter of the cylinder. The cylinder and the rod have some friction between them, and the rod for expanding/contacting is sliding by a human power.

In addition, the elevating member 20 includes a slope adjusting unit for changing an angle in case of an elevation of the upper frame 30.

As shown in FIG. 2, the slope adjusting unit includes an inclined plane 13 having a slope guide in a certain area at a back side of the lower frame 10 in order to guide the lower roller 24 positioned at the end of the elevating bar 21 and to increase a height of one side of the bed (a head side of the bed) in case of the elevation of the upper frame 30.

Since the elevating bars 21 are provided in pair at the left and right side, and rotatably coupled by the central axis 22 at each center, ends of the elevating bars 21 are respectively fixed to the lower frame 10 and the upper frame 30 by the lower hinge and the upper hinge 31, the upper roller 23 and the lower roller 24 at other ends of the bars 21 respectively moves in case of an elevation of the upper frame 30, and specially the lower roller 24 is lowered by a certain depth along the inclined plane 13 to incline the upper frame 30, the coupled bed sheet 40 and the bathtub sheet 50.

For the elevating power unit 70, a pneumatic cylinder is used, and the pneumatic cylinder is expanded/contracted by pressure of compressed air supplied from the external pneumatic supply device, and it is understood that it may use a screw method for rotating by an electric motor as another embodiment.

In other words, the elevating power unit 70 of the screw method is expanded/contracted at both sides of the elevating bars 21, and includes at one side a driving motor operated by electric power and a bolt rotated by the motor, and at the other side a nut coupled with the bolt in order to change a coupling angle of the elevating bars 21 and controlling a height of the upper frame 30.

In the present invention, as shown in FIG. 1, a patient can easily lien down on the bed by lowering the upper frame 30 and the elevating member 20, and then the upper frame 30 and the elevating member 20 can be lift to a proper height as shown in FIG. 3. Therefore, the bed can be used more conveniently.

Particularly, since the bathtub sheet 50 provided as one piece with the bed sheet 40 is waterproof and flexible, the bathtub sheet 50 can be folded as shown in FIG. 1, or the bathtub sheet 50 can be unfolded upward and supported in that state by the supporting member 60 for providing a bathtub function.

In the present invention, a height of a head part of a patient is made a little higher than that of a leg part when the upper frame 30 is lifted as shown in FIG. 3, thereby making the job of bathing patient in bed easier for both the patient and a caregiver.

The present invention makes easier the job of bathing or showering persons who are not able to move around freely.

The bed with bathtub of the present invention has a very simple structure, and can be used very conveniently as a medical instrument. It is assumed that the demand for the instrument will be numerous since the number of sick patients and the aging population is greatly increased due to stroke or other diseases, and the present invention has a great potential for an industrial use.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A bed provided with a bathtub, comprising:
a lower frame comprising casters under corners for mobility;
an upper frame having an adjustable height and positioned above the lower frame;
an elevating member comprising a pair of elevating bars rotatably coupled by a central axis, which are positioned between the lower frame and the upper frame at both a left side and a right side, for supporting the upper frame and adjusting a height of the upper frame, an elevating power unit, which is positioned at both sides of the elevating bars, for changing a coupling angle of the elevating bars by the expansion and contraction to control a height of the upper frame, and a slope adjusting unit for changing an angle in case of an elevation of the upper frame;
a bathtub sheet, which is integrally formed with a bed sheet on the upper frame and is made of a water resistant material of Urethane to form a bathtub having a certain depth, comprising an outline part of an elastic material for keeping an external shape and a drain at a bottom side; and
a supporting member for supporting the bathtub sheet, which is positioned between the outline part of the bathtub sheet and the upper frame.

2. The bed of claim 1, wherein side ends of the elevating bars are rotatably coupled to the lower frame and the upper frame respectively by a lower hinge and an upper hinge, and other sides of the bars are respectively provided with a lower roller and an upper roller.

3. The bed of claim 1, wherein the slope adjusting unit comprises:
an inclined plane comprising a slope guide in a certain area at a back side of the lower frame in order to guide the lower roller positioned at the end of the elevating bar and to increase a height of one side of the bed (a head side of the bed) in case of an elevation of the upper frame; and
a lower roller for rolling along the inclined plane, which is positioned at an end of the elevating bar.

4. The bed of claim 1, wherein the elevating power unit is a pneumatic cylinder, which is positioned at both sides of the elevating bars, for being expanded/contracted by pressure of compressed air supplied from an external pneumatic supply device in order to change a coupling angle of the elevating bars to change a height of the upper frame.

5. The bed of claim 1, wherein the elevating power unit is positioned at both sides of the elevating bars, and comprises at one side a driving motor operated by electric power, a bolt rotated by the motor, and at the other side a nut coupled with the bolt in order to change a coupling angle of the elevating bars and controlling a height of the upper frame by an expansion/contraction.

6. A bed provided with a bathtub, comprising:
a lower frame comprising a caster under corners to obtain the mobility;
an upper frame having an adjustable height and positioned above the lower frame;
an elevating member, which are positioned between the lower frame and the upper frame, for supporting the upper frame and adjusting a height of the upper frame;
a bathtub sheet, which is integrally formed with a bed sheet on the upper frame and is made of a water resistant material to form a bathtub having a certain depth, comprising an outline part for keeping an external shape and a drain at a bottom side; and
a supporting member for supporting the bathtub sheet, which is positioned between the outline part of the bathtub sheet and the upper frame, the bed sheet on the upper frame being provided with a hot water pipe in order to supply heat to water in bathtub.

7. A bed provided with a bathtub, comprising:
a lower frame comprising a caster under corners to obtain the mobility;
an upper frame having an adjustable height and positioned above the lower frame;
an elevating member, which are positioned between the lower frame and the upper frame, for supporting the upper frame and adjusting a height of the upper frame;
a bathtub sheet, which is integrally formed with a bed sheet on the upper frame and is made of a water resistant material to form a bathtub having a certain depth, comprising an outline part 51 for keeping an external shape and a drain at a bottom side; and
a supporting member for supporting the bathtub sheet, which is positioned between the outline part of the bathtub sheet and the upper frame,
wherein the supporting member comprises:
a cylinder fixed to the upper frame; and
a rod fixed to the outline part of the bathtub sheet, for sliding in the cylinder and being expanded/contracted by human power.
